(19) United States
(12) Patent Application Publication
(10) Pub. No.: US 2016/0106258 A1
(43) Pub. Date: Apr. 21, 2016

(54) HEATING DEVICE WITH ALARM FUNCTION

(71) Applicant: Ming-Yi Yen, Kaohsiung City (TW)

(72) Inventors: Ming-Yi Yen, Kaohsiung City (TW); Yi-Cheng Tsao, Hualien County (TW); Chih-Chiang Chang, Taipei City (TW)

(21) Appl. No.: 14/875,683

(22) Filed: Oct. 5, 2015

Related U.S. Application Data
(60) Provisional application No. 62/066,374, filed on Oct. 21, 2014.

(51) Int. Cl. A47J 31/52; A47J 31/56

(52) U.S. Cl. CPC A47J 31/52; A47J 31/56

(57) ABSTRACT

A heating device with an alarm function includes an alarm unit, an input module, a heating unit, a temperature sensor, and a controller. The input module is used for setting a target temperature and an alarm activation time. The heating unit is used for heating a container. The temperature sensor is used for sensing a current temperature of the container. The controller controls the heating unit to heat the container when a current time reaches a predetermined time previous to the alarm activation time. The controller selectively controls the heating unit to stop heating the container or keep the current temperature at the target temperature when the current temperature reaches the target temperature or when the current time reaches the alarm activation time. The controller controls the alarm unit to output an alarm when the current time reaches the alarm activation time.

### CROSS REFERENCE TO RELATED APPLICATIONS

This application claims the benefit of U.S. Provisional Application No. 62/066,374, which was filed on Oct. 21, 2014, and is incorporated herein by reference.

### BACKGROUND OF THE INVENTION

1. Field of the Invention

The invention relates to a heating device with an alarm function and, more particularly, to a heating device with an alarm function capable of heating a container and outputting an alarm according to a target temperature and an alarm activation time.

2. Description of the Prior Art

In general, an alarm clock is a clock that helps to wake up a user by issuing an alarm, such as a sound or a melody, at a specific set time, such as the time at which the sun rises. When the room temperature is cool and dry, people could sometimes wake up thirsty and would like to have a warm drink upon waking up. Therefore, people woke up by an alarm clock and then use a boiler to obtain liquid with suitable temperature to drink by mixing the just boiled liquid from the boiler with cooler liquid. However, such process requires a few minutes to be completed from waking up to drinking the liquid with suitable temperature, thereby making it impossible for people, who just woke up by the alarm clock, to drink a liquid with suitable temperature immediately.

### SUMMARY OF THE INVENTION

The invention provides a heating device with an alarm function capable of heating a container and outputting an alarm according to a target temperature and an alarm activation time, so as to solve the aforesaid problems.

According to an embodiment of the invention, a heating device with an alarm function comprises an alarm unit, an input module, a heating unit, a temperature sensor, and a controller, wherein the controller is electrically connected to the alarm unit, the input module, the heating unit, and the temperature sensor. The input module is used for setting a target temperature and an alarm activation time. The heating unit is used for heating a container. The temperature sensor is used for sensing a current temperature of the container. The controller has a timer for providing a current time. The controller controls the heating unit to heat the container when the current time reaches a predetermined time previous to the alarm activation time, determines whether the current temperature reaches the target temperature, and determines whether the current time reaches the alarm activation time. The controller selectively controls the heating unit to stop heating the container or keep the current temperature at the target temperature when the current temperature reaches the target temperature or when the current time reaches the alarm activation time. The controller controls the alarm unit to output an alarm when the current time reaches the alarm activation time.

As mentioned in the above, before sleeping, a user may fill the container with a liquid, put the container with the liquid on the heating device of the invention, and operate the input module to set the target temperature for the container and the alarm activation time for the alarm unit. Afterward, the controller of the heating device will control the heating unit to heat the container when the current time reaches the predetermined time previous to the alarm activation time. That is to say, the controller of the heating device will control the heating unit to heat the container with the liquid gradually over time before the user wakes up by the alarm output by the alarm unit. It should be noted that the controller may selectively control the heating unit to stop heating the container or keep the current temperature at the target temperature when the current temperature reaches the target temperature or when the current time reaches the alarm activation time. Then, the controller will control the alarm unit to output the alarm when the current time reaches the alarm activation time. Since the container with the liquid has been heated by the heating unit, the user who just wakes up by the alarm output by the alarm unit can drink the heated liquid contained in the container immediately.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram illustrating a heating device with an alarm function according to an embodiment of the invention.

FIG. 2 is a functional block diagram illustrating a heating device with an alarm function according to another embodiment of the invention.

FIG. 3 is a functional block diagram illustrating a heating device with an alarm function according to another embodiment of the invention.

### DETAILED DESCRIPTION

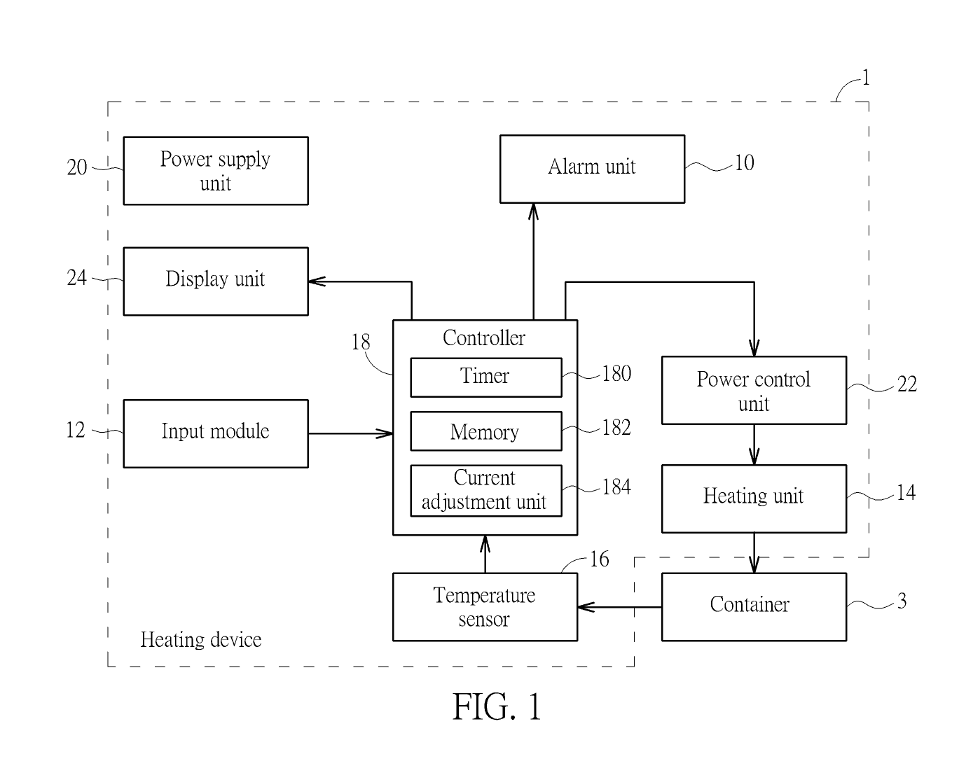

Referring to FIG. 1, FIG. 1 is a functional block diagram illustrating a heating device 1 with an alarm function according to an embodiment of the invention. As shown in FIG. 1, the heating device 1 with an alarm function comprises an alarm unit 10, an input module 12, a heating unit 14, a temperature sensor 16, a controller 18, a power supply unit 20, a power control unit 22, and a display unit 24. The controller 18 is electrically connected to the alarm unit 10, the input module 12, the heating unit 14, the temperature sensor 16, the power control unit 22, and the display unit 24. The power control unit 22 is further electrically connected to the heating unit 14. The power supply unit 20 is used for supplying power to the alarm unit 10, the input module 12, the heating unit 14, the temperature sensor 16, the controller 18, the power control unit 22, and the display unit 24. In this embodiment, the power supply unit 20 may receive commercial AC power, rectify it, and supply predetermined DC power to all of the aforesaid components. However, in another embodiment, the power supply unit 20 may receive DC power immediately and supply DC power to all of the aforesaid components.

In practical applications, the alarm unit may be a speaker or the like; the input module 12 may be a touch panel, a keyboard, or the like; the heating unit 14 may be an infrared heater, an electromagnetic heater, a resistance heater, or the like; the power supply unit 20 may be a battery or the like; and the display unit 24 may be a liquid crystal display panel or the like. Furthermore, the power supply unit 20 may further comprise a built-in battery (not shown) so that whenever the heating device 1 is unplugged, the timing function of the invention can still be kept for a while.

The alarm unit 10 may be selectively turned on and off in response to an alarm control signal output by the controller 18, so as to output an alarm (e.g. sound, melody, etc.). The input module 12 is used for setting a target temperature and an alarm activation time by a user. The controller 18 may output the alarm control signal to the alarm unit 10 at the alarm activation time, so as to control the alarm unit 10 to output the alarm at the alarm activation time. The heating unit 14 is used for heating a container 3 using power supplied by the power supply unit 20. In this embodiment, the power control unit 22 may be selectively switched on and off in response to a temperature control signal output by the controller 18, so as to control the power supplied by the power supply unit 20 to the heating unit 14. For example, the controller 18 may switch on the power control unit 22 to control the heating unit 14 to heat the container 3 or switch off the power control unit 22 to control the heating unit 14 to stop heating the container 3. The power control unit 22 may be implemented by circuit design. The temperature sensor 16 is used for sensing a current temperature of the container 3 and sending back signal to the controller 18.

The controller 18 may have a timer 180, a memory 182, and a current adjustment unit 184. The timer 180 has a clock function for providing a current time. The timer 180 may be implemented in the form of a program. In this embodiment, a predetermined time to start the temperature control of the invention may be preset and stored in the memory 182 by a manufacturer of the heating device 1 or, alternatively, set by the input module 12 and stored in the memory 182 by a user of the heating device 1. Still further, the target temperature and the alarm activation time set by the input module 12 may also be stored in the memory 182. The current adjustment unit 184 is used for adjusting an amount of current flowing through the heating unit 14, such that the amount of current flowing through the heating unit 14 varies based on the temperature control signal output by the controller 18. Accordingly, the heating unit 14 can heat the container 3 gradually or keep the current temperature of the container 3. The current adjustment unit 184 may be implemented by a solid state relay (SSR) . It should be noted that the current adjustment unit 184 may be integrated in the controlled 18 or separated from the controller 18 according to practical applications.

Furthermore, in this embodiment, the controller 18 may control the display unit 24 to display at least the current temperature of the container 3 sensed by the temperature sensor 16 and the current time provided by the timer 180. For example, the controller 18 may output a temperature display signal and a time display signal to the display unit 24, so as to control the display unit 24 to display the current temperature and the current time. In other embodiments, the controller 18 may control the display unit 24 to further display the target temperature and/or the alarm activation time set by the input module 12 according to practical applications.

The operation of the heating device 1 with an alarm function will be described below. First of all, a user operates the input module 12 to set a target temperature to be, for example, 50 degrees C. and set an alarm activation time to be, for example, 06:30:00 a.m. The controller 18 always executes the timer program and the temperature control program stored in the memory 180. The predetermined time to start the temperature control of the invention maybe set to be 06:20:00 a.m., i.e. ten minutes previous to the alarm activation time. Accordingly, when the current time reaches 06:20:00 a.m. (i.e. the predetermined time), the controller 18 will output a temperature control signal to switch on the power control unit 22, so as to supply current to the heating unit 14. At the same time, the current adjustment unit 184 of the controller 18 will adjust the amount of current flowing through the heating unit 14 according to a feedback signal sent back by the temperature sensor 16. By the aforesaid operation, the heating unit 14 will gradually heat up the container 3 over time. In the meanwhile, the controller 18 will determine whether the current temperature of container 3 sensed by the temperature sensor 16 reaches the target temperature (i.e. 50 degrees C. in this embodiment) and determine whether the current time reaches the alarm activation time (i.e. 06:30:00 a.m. in this embodiment).

In this embodiment, the controller 18 may selectively control the heating unit 14 to stop heating the container 3 or keep the current temperature of the container 3 at the target temperature when the current temperature reaches the target temperature or when the current time reaches the alarm activation time. Furthermore, the controller 18 will control the alarm unit 10 to output an alarm (e.g. sound, melody, etc.) when the current time reaches the alarm activation time.

There are several embodiments below for describing the temperature control of the invention.

### First Embodiment

The controller 18 may control the heating unit 14 to stop heating the container 3 when the current time reaches the alarm activation time but the current temperature of the container 3 has not reached the target temperature yet. For example, when the current time reaches 06:30:00 a.m. (i.e. the alarm activation time) but the current temperature of the container 3 just reaches 48 degrees C. lower than 50 degrees C. (i.e. the target temperature), the controller 18 will output an alarm control signal to control the alarm unit 10 to output an alarm to wake up the user and output a temperature control signal to switch off the power control unit 22 to control the heating unit 14 to stop heating the container 3. Even though the current temperature of the container 3 does not reach the target temperature, the user who just wakes up by the alarm still can drink the heated liquid contained in the container 3 immediately.

### Second Embodiment

The controller 18 may control the heating unit 14 to stop heating the container 3 when the current temperature reaches the target temperature but the current time has not reached the alarm activation time yet, so as to prevent the liquid contained in the container 3 from boiling up and spilling over. For example, when the current temperature of the container 3 reaches 50 degrees C. (i.e. the target temperature) but the current time just reaches 06:28:00 a.m. previous to 06:30:00 a.m. (i.e. the alarm activation time), the controller 18 will output a temperature control signal to switch off the power control unit 22 to control the heating unit 14 to stop heating the container 3. Afterward, when the current time reaches 06:30:00 a.m. (i.e. the alarm activation time), the controller 18 will output an alarm control signal to control the alarm unit 10 to output an alarm to wake up the user. Then, the user who just wakes up by the alarm can drink the heated liquid with the target temperature contained in the container 3 immediately.

### Third Embodiment

The controller 18 may control the heating unit 14 to keep the current temperature at the target temperature when the current temperature reaches the target temperature but the current time has not reached the alarm activation time yet, so as to prevent the liquid contained in the container 3 from cooling before the user wakes up by the alarm. For example, when the current temperature of the container 3 reaches 50 degrees C. (i.e. the target temperature) but the current time just reaches 06:28:00 a.m. previous to 06:30:00 a.m. (i.e. the alarm activation time), the controller 18 will control the current adjustment unit 184 to adjust the amount of current flowing through the heating unit 14, so as to control the heating unit 14 to keep the current temperature of the container 3 at the target temperature. Afterward, when the current time reaches 06:30:00 a.m. (i.e. the alarm activation time), the controller 18 will output an alarm control signal to control the alarm unit 10 to output an alarm to wake up the user. Then, the user who just wakes up by the alarm can drink the heated liquid with the target temperature contained in the container 3 immediately. It should be noted that when the current time reaches the alarm activation time, the controller 18 may control the heating unit 14 to stop heating the container 3 or keep the current temperature of container 3 at the target temperature before the user takes the container 3 from the heating device 1 to drink the liquid.

### Fourth Embodiment

The controller 18 may control the heating unit 14 to heat the container 3 continuously when the current time reaches the alarm activation time but the current temperature has not reached the target temperature yet. For example, when the current time reaches 06:30:00 a.m. (i.e. the alarm activation time) but the current temperature of the container 3 just reaches 40 degrees C. lower than 50 degrees C. (i.e. the target temperature), the controller 18 will output an alarm control signal to control the alarm unit 10 to output an alarm to wake up the user. If the user does not take the container 3 from the heating device 1 to drink the liquid immediately, the control may control the heating unit 14 to heat the container 3 continuously, such that the liquid contained in the container 3 may be heated to the target temperature (i.e. 50 degrees C.) after the user wakes up by the alarm. It should be noted that when the current temperature of the container 3 reaches the target temperature, the controller 18 may control the heating unit 14 to stop heating the container 3 or keep the current temperature of the container 3 at the target temperature, so as to prevent the liquid contained in the container 3 from boiling up and spilling over.

It should be noted that the aforesaid operation embodiments may be programmed to allow the user to select through the input module 12 and the display unit 24. Furthermore, the predetermined time to start the temperature control may be programmed according to the material of the container 3, the capacity of the container 3, and/or the liquid type and stored in the memory 182 by a manufacturer of the heating device 1. Needless to say, the invention may allow the user to adjust the predetermined time to start the temperature control according to his/her preference by the input module 12. Still further, the input module 12 may be also used for setting current time, turning on or off the heating function of the invention. Moreover, a snooze button (not shown) may be disposed on the heating device 1 and electrically connected to the controller. When the alarm unit 10 is activated, the user may press the snooze button to turn off the alarm unit temporarily and snooze for a while.

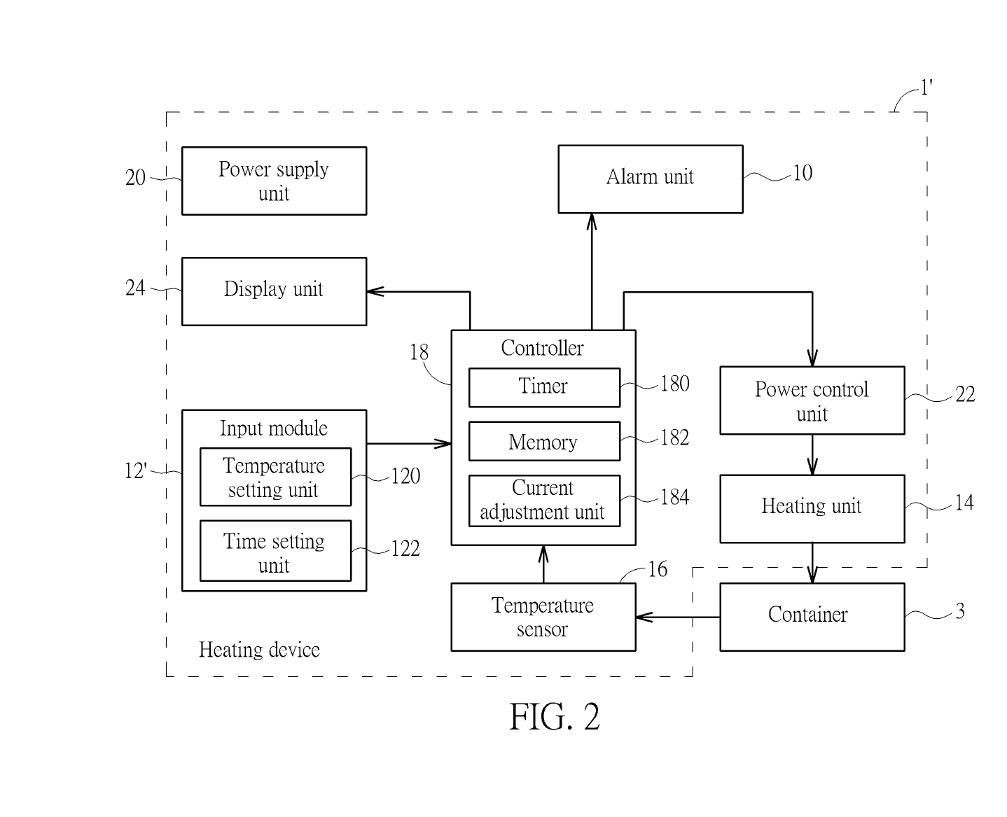

Referring to FIG. 2, FIG. 2 is a functional block diagram illustrating a heating device 1′ with an alarm function according to another embodiment of the invention. The main difference between the heating device 1′ and the aforesaid heating device 1 is that the input module 12′ of the heating device 1′ comprises a temperature setting unit 120 for setting the target temperature and a time setting unit 122 for setting the alarm activation time, as shown in FIG. 2. In this embodiment, the temperature setting unit 120 may consist of a bar and a variable resistor. The user may push or pull the bar to adjust the variable resistor, so as to set the target temperature. Furthermore, the time setting unit 122 maybe a touch panel, a keyboard, or the like. It should be noted that the same elements in FIG. 2 and FIG. 1 are represented by the same numerals, so the repeated explanation will not be depicted herein again.

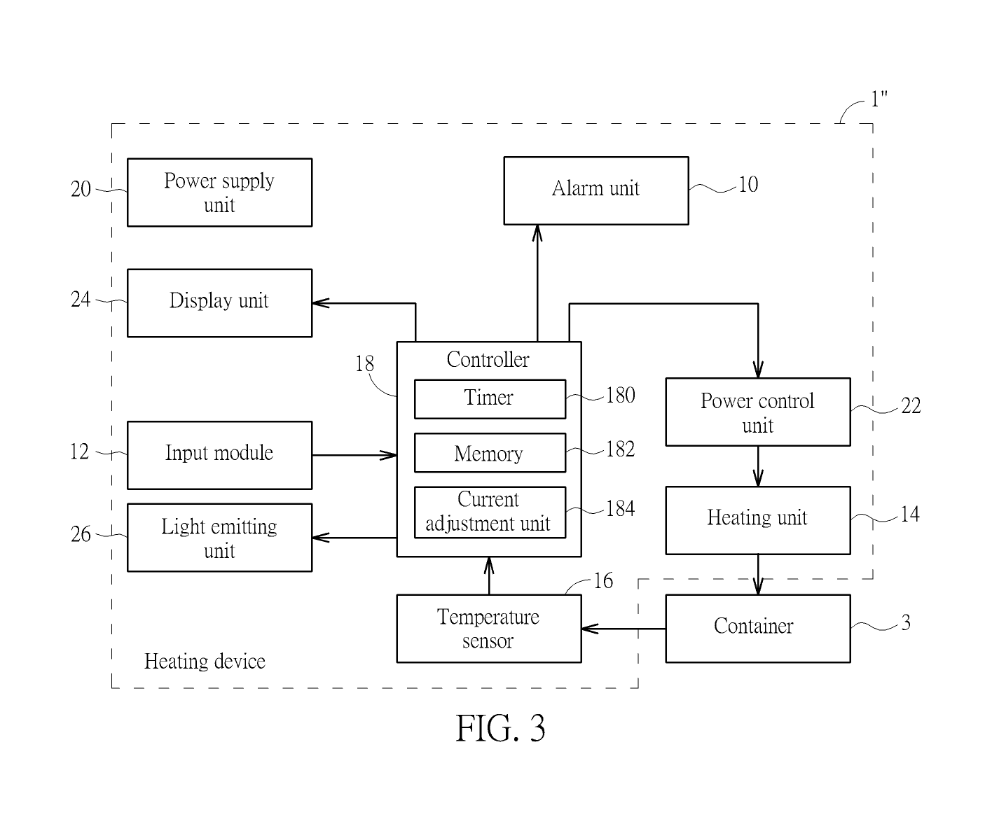

Referring to FIG. 3, FIG. 3 is a functional block diagram illustrating a heating device 1″ with an alarm function according to another embodiment of the invention. The main difference between the heating device 1″ and the aforesaid heating device 1 is that the heating device 1″ further comprises a light emitting unit 26 electrically connected to the controller 18, as shown in FIG. 3. The controller 18 may controls the light emitting unit 26 to emit light, so as to assist the user in locating the heating device 1′ in a dark environment. It should be noted that the same elements in FIG. 3 and FIG. 1 are represented by the same numerals, so the repeated explanation will not be depicted herein again.

As mentioned in the above, before sleeping, a user may fill the container with a liquid, put the container with the liquid on the heating device of the invention, and operate the input module to set the target temperature for the container and the alarm activation time for the alarm unit. Afterward, the controller of the heating device will control the heating unit to heat the container when the current time reaches the predetermined time previous to the alarm activation time. That is to say, the controller of the heating device will control the heating unit to heat the container with the liquid gradually over time before the user wakes up by the alarm output by the alarm unit. It should be noted that the controller may selectively control the heating unit to stop heating the container or keep the current temperature at the target temperature when the current temperature reaches the target temperature or when the current time reaches the alarm activation time. Then, the controller will control the alarm unit to output the alarm when the current time reaches the alarm activation time. Since the container with the liquid has been heated by the heating unit, the user who just wakes up by the alarm output by the alarm unit can drink the heated liquid contained in the container immediately.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A heating device with an alarm function comprising:
an alarm unit;
an input module for setting a target temperature and an alarm activation time;
a heating unit for heating a container;
a temperature sensor for sensing a current temperature of the container; and
a controller electrically connected to the alarm unit, the input module, the heating unit, and the temperature sensor, the controller having a timer for providing a current time;
wherein the controller controls the heating unit to heat the container when the current time reaches a predetermined time previous to the alarm activation time, determines whether the current temperature reaches the target temperature, and determines whether the current time reaches the alarm activation time; the controller selectively controls the heating unit to stop heating the container or keep the current temperature at the target temperature when the current temperature reaches the target temperature or when the current time reaches the alarm activation time; and the controller controls the alarm unit to output an alarm when the current time reaches the alarm activation time.

2. The heating device of claim 1, wherein the predetermined time is preset and stored in a memory of the controller.

3. The heating device of claim 1, wherein the predetermined time is set by the input module.

4. The heating device of claim 1, wherein the controller controls the heating unit to stop heating the container when the current time reaches the alarm activation time but the current temperature has not reached the target temperature yet.

5. The heating device of claim 1, wherein the controller controls the heating unit to stop heating the container when the current temperature reaches the target temperature but the current time has not reached the alarm activation time yet.

6. The heating device of claim 1, wherein the controller controls the heating unit to keep the current temperature at the target temperature when the current temperature reaches the target temperature but the current time has not reached the alarm activation time yet.

7. The heating device of claim 1, wherein the controller controls the heating unit to heat the container continuously when the current time reaches the alarm activation time but the current temperature has not reached the target temperature yet.

8. The heating device of claim 1, further comprising a power supply unit for supplying power to the alarm unit, the input module, the heating unit, the temperature sensor, and the controller.

9. The heating device of claim 1, further comprising a power control unit electrically connected to the heating unit and the controller, the controller switching on the power control unit to control the heating unit to heat the container or switching off the power control unit to control the heating unit to stop heating the container.

10. The heating device of claim 1, wherein the controller further has a current adjustment unit for adjusting an amount of current flowing through the heating unit.

11. The heating device of claim 1, further comprising a display unit electrically connected to the controller, the controller controlling the display unit to display at least the current temperature and the current time.

12. The heating device of claim 1, wherein the input module comprises a temperature setting unit for setting the target temperature and a time setting unit for setting the alarm activation time.

13. The heating device of claim 1, further comprising a light emitting unit electrically connected to the controller, the controller controlling the light emitting unit to emit light.
